(19) United States
(12) Patent Application Publication
(10) Pub. No.: US 2002/0165902 A1
(43) Pub. Date: Nov. 7, 2002

(54) Independent log manager

(76) Inventors: Mary Thomas Robb, Fort Collins, CO (US); Humberto A. Sanchez II, Ft Collins, CO (US); Michael Scheetz, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/848,711

(22) Filed: May 3, 2001

(51) Int. Cl. G06F 15/16

(52) U.S. Cl. 709/202

(57) ABSTRACT

A method and apparatus of logging events independently and separately from other processes in a computer system are disclosed. A method for logging events by cloning a log entry submitted by a consumer and releasing control of the log entry to the consumer so that execution of an event may continue is disclosed. A log manager that receives requests for writing event log entries to a log file while enabling the execution of the event to continue independently is disclosed.

### TECHNICAL FIELD

The technical field generally relates to logging of computer system events and more particularly to logging managers.

### BACKGROUND

Many computer systems, especially computer network systems in which a few people manage a large number of machines, include a complete audit trail of access to records of the configuration events and task events that users ran or attempted to run. Logging systems record these events in log files that are generally accessible by systems administrators.

Unfortunately, most logging systems are not separate processes that run independently of the rest of the computer system. If the logging system halts operation, the rest of the system was affected. For example, if daemons were waiting to log a task that the daemons were executing, and the logging system halts operation, the daemon would have to wait until the logging system operation was restored.

Furthermore, most logging systems require that a configuration or task event be logged before the configuration or task event is executed. As such, these logging systems often delay completion of the task or configuration event. Finally, most logging systems are single-threaded so that the logging system can only manage one log entry at a time.

A multiple-threaded log manager that queues log entries and frees up the daemons requesting the writing of the log entries is not found in the prior art. Likewise, a log manager that runs independently and separately from the other processes in a computer system is not found in the prior art. Further, a log manager that does not block the execution of tasks and configuration events on the computer systems is not found in the prior art.

### SUMMARY

A method and apparatus for logging log entries independently and separately from other processes in a computer system is disclosed. An embodiment comprises a multiple-threaded log manager that queues log entries and frees up the daemons requesting the writing of the log entries. In an embodiment, a log manager does not block the execution of tasks and configuration events on a computer system. An alternate embodiment comprises a log manager that runs independently and separately from the other processes in a computer system.

These and other advantages are achieved by a method for logging events independently and separately from other processes in a computer system, comprising a consumer initiating an event, wherein the event is a process executed on a computer system, creating a log entry, wherein the log entry comprises information that describes the event, requesting that the log entry information be written to a log file, whereby the consumer surrenders control of the log entry, pausing execution of the event, and, releasing control of the log entry to the consumer, so that execution of the event can resume, prior to writing the log entry information to the log file, wherein releasing control of the log entry to the consumer comprises cloning the log entry, wherein the log entry clone is a copy of the log entry that comprises the log entry information.

These and other advantages are also achieved by a computer readable medium containing instructions for logging events independently and separately from other processes in a computer system, by a consumer initiating an event, wherein the event is a process executed on a computer system, creating a log entry, wherein the log entry comprises information that describes the event, requesting that the log entry information be written to a log file, whereby the consumer surrenders control of the log entry, pausing execution of the event, and, releasing control of the log entry to the consumer, so that execution of the event can resume, prior to writing the log entry information to the log file.

Likewise, these and other advantages are achieved by a computer system that supports logging events independently and separately from other processes in a computer system, comprising, a memory, a secondary storage device comprising a log file, a processor that runs an application, wherein the application comprises a consumer, wherein the consumer initiates an event that is a process executed by the processor, creates a log entry comprising information that describes the event, and requests that the log entry information be written to the log file, a multiple-threaded log manager, wherein the log manager, independently and separately from other processes, logs events, by receiving the log entry from the consumer, thereby obtaining control of the log entry and pausing execution of the event, and, releasing control of the log entry to the consumer, so that execution of the event can resume, prior to writing the log entry information to the log file.

### BRIEF DESCRIPTION OF THE FIGURES

The detailed description will refer to the following drawings, in which like numbers refer to like items, and in which:

FIG. 1 is a block diagram of a computer system on which an embodiment of the log manager may be run.

FIG. 2 is a block diagram illustrating an embodiment of the log manager

FIGS. 3a-3b are flowcharts illustrating a method according to an embodiment of the log manager.

FIGS. 4a-4c are sequence diagrams illustrating a method according to an embodiment of the log manager.

### DETAILED DESCRIPTION

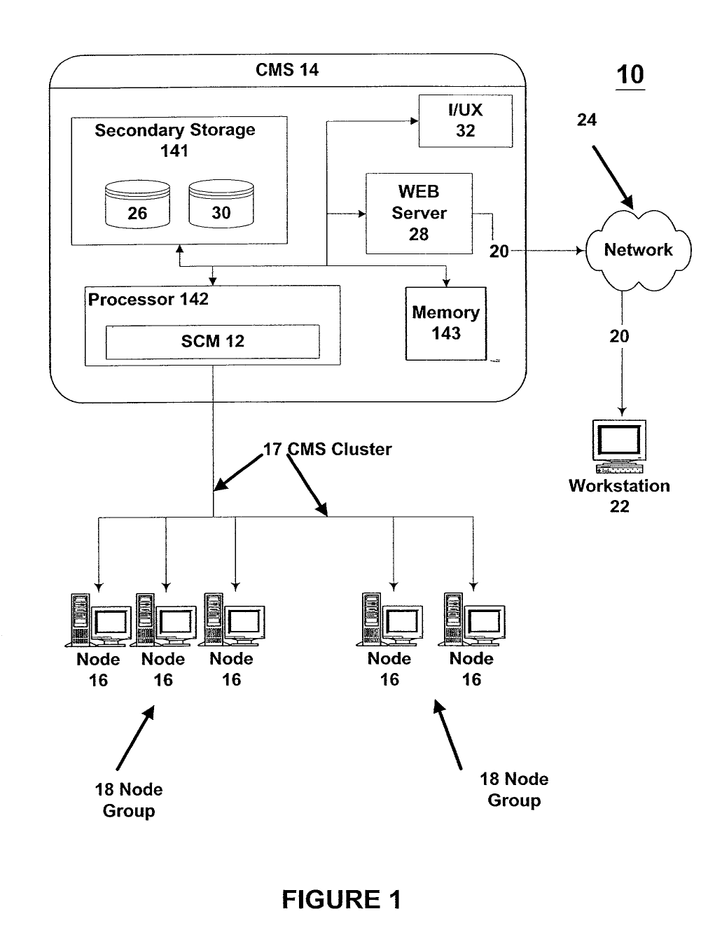

A log manager system and method may be used with a computer system that log events that occur within the computer system. FIG. 1 illustrates a computer network system with which the log manager may be used. The computer network system 10 comprises a ServiceControl Manager (“SCM”) 12 running on a Central Management Server (“CMS”) 14 and one or more nodes 16 managed by the SCM 12 on the CMS 14. Together the one or more nodes 16 managed by the SCM 12 make up a SCM cluster 17. A group of nodes 16 may be organized as a node group 18.

The CMS 14 preferably is an HP-UX 11.x server running the SCM 12 software. The CMS 14 includes a memory 143, a secondary storage device 141, a processor 142, an input device (not shown), a display device (not shown), and an output device (not shown). The memory, a computer readable medium, may include, RAM or similar types of memory, and it may store one or more applications for execution by processor, including the SCM 12 software. The secondary storage device, a computer readable medium, may include a hard disk drive, floppy disk drive, CD-ROM drive, or other types of non-volatile data storage. The processor executes the SCM 12 software and other application(s), which are stored in memory or secondary storage, or received from the Internet or other network 24, in order to provide the functions and perform the methods described in this specification, and the processing may be implemented in software, such as software modules, for execution by the CMS 14 and modes 16. The SCM 12 is preferably programmed in Java® and operates in a Java environment. See ServiceControl Manager Technical Reference, HP® part number: B8339-90019, available from Hewlett-Packard Company, Palo Alto, Calif., which is hereby incorporated by reference, for a more detailed description of the SCM 12. The ServiceControl Manager Technical Reference, HP® part number: B8339-90019 is also accessible at http://www.software.hp.com.products/scmgr.

In addition to the SCM 12 software and the HP-UX server described above, the CMS 14 preferably also comprises a data repository 26 for the SCM cluster 17, a web server 28 that allows web access to the SCM 12 and a depot 30 comprising products used in the configuring of nodes, and a I/UX server 32. Although the CMS 14 is depicted with various components, one skilled in the art will appreciate that this server can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the CMS 14 (and/or the nodes 16) to perform a particular method, such as those described herein.

The nodes 16 are preferably HP-UX servers or other servers and they may be referred to as “managed nodes” or simply as “nodes”. The concept of a node 16 is that the mode 16 represents a single instance of HP-UX running on some hardware. The node 16 may comprise a memory, a secondary storage device, a processor, an input device, a display device, and an output device. The CMS 14 is preferably also a managed node 16, so that multi-system aware (“MSA”) tools can be invoked on the CMS 14.

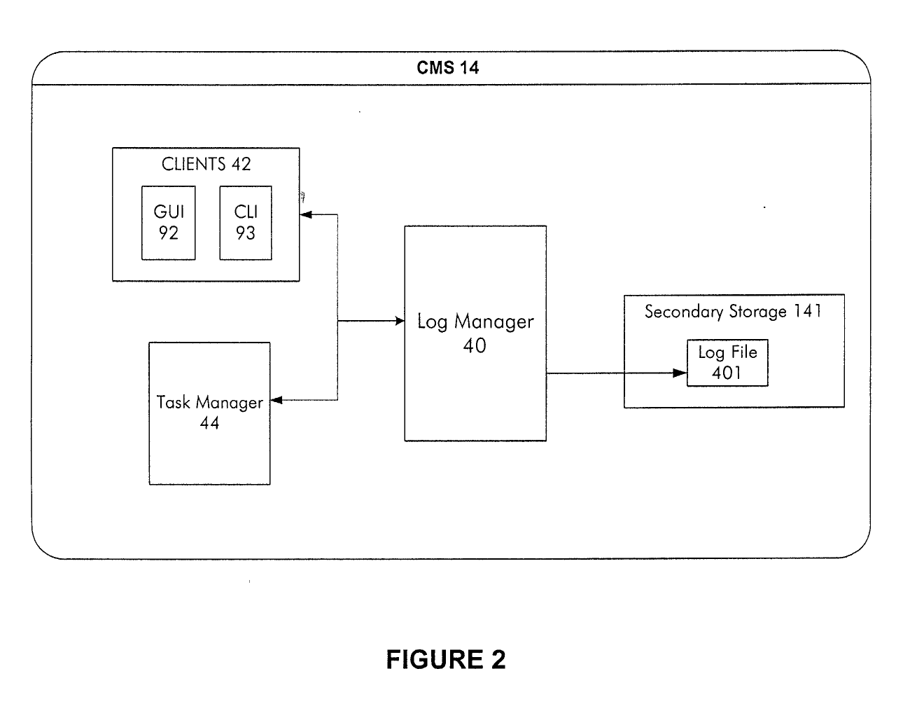

The SCM 12 preferably comprises modules, such as a log manager and a task manager (shown in FIG. 2), that perform specific SCM functions. A user may access the SCM 12, and the SCM 12 modules, through clients of the SCM 12, such as graphical user interfaces (“GUIs”) and command line interfaces (“CLIs”). Referring to FIG. 1, the SCM 12 preferably supports managing a single SCM cluster 17 from a single CMS 14. All tasks performed on the SCM cluster 17 are initiated on the CMS 14 either directly or remotely, for example, by reaching the CMS 14 using a Web connection 20. Therefore, a workstation 22 at which a user sits only needs the Web connection 20 over a network 24 to the CMS 14 in order to perform tasks on the SCM cluster 17. The workstation 22 preferably comprises a display, a memory, a processor, a secondary storage, an input device and an output device.

Object-oriented programming is a method of programming that pairs programming tasks and data into re-usable chunks known as objects. Each object comprises attributes (i.e., data) that define and describe the object. Preferably, Java objects operating in Java Virtual Machines (“JVM”) provide the functionality of the SCM 12. When a user, through a GUI or CLI, wants to access the functionality of the SCM 12 (e.g., to retrieve, save or modify (e.g., change or delete) persistent data (e.g., in the data repository 26) or to run a tool on a node(s) or node group(s)), the GUI or the CLI instructs a Java class(es) to be instantiated. Java classes are meta-definitions that define the structure of a Java object. Java classes, when instantiated, create instances of the Java classes and are then considered Java objects. Methods within Java objects are used to get or set attributes of the Java object and to change the state of the Java object.

A tool is an executable that performs a process, and a tool object defines each tool. A role object defines the role a user may have on a certain node(s) or node group(s), where each role has one or more associated tools that a user with the role might execute. An authorization object defines the node(s) and node group(s) a user is authorized to access and what roles the user has on the authorized node(s) or node group(s).

The objects and classes discussed below are named with a prefix “Mx”. The Mx prefix indicates the application using the objects and classes (the SCM 12) and is merely exemplary. Indeed, the names of classes, objects and methods discussed below are exemplary, are not intended to be limiting and are merely used for ease of discussion.

As shown in FIG. 2, a Log Manager 40 is an independent module of the SCM 12 that is used by SCM 12 clients 42 (e.g., GUIs 92 and CLIs 93) and a task manager 44, to log configuration and task events that occur within the computer network system 10. Configuration events include the configuration of objects, such as creating, deleting and/or modifying user, node, node group, tool, role or authorization objects and their object attributes. Task events include the running of tools. The Log Manager 40 preferably manages multiple and concurrent write requests to a log file 401, localizes log entries (e.g., writes the log entries in the local language), writes log entries to the log file 401, handles logic to keep related log entries together and causes the log file 401 to “roll-over” at a user-specified size. The log file 401 is preferably a text file (e.g., an ASCII text file) stored on the CMS 14 (e.g., in secondary storage). Write requests are generally statements that an event is happening on the system 10.

The Log Manager 40 preferably is a long-running process with the Log Managers daemon. The Log Manager 40 is multi-threaded and services a first-in-first-out (“fifo”) queue. One thread of the Log Manager 40 places write requests on the fifo queue and returns control to a caller (e.g., a client 42 or the task manager 44) so as not to block the caller from continuing the event process. Another Log Manager thread checks the fifo queue for a write request, dequeues the write request, and writes a log entry to the log file 401.

Because the Log Manager 40 uses multiple threads, the performance of the Log Manager 40 and the length of the fifo queue does not affect performance of the configuration and task events. The configuration and task events do not wait until after they are logged to execute. Consequently, the Log Manager 40 does not delay the execution of events that request a log entry. Moreover, since the Log Manager 40 is a separate module of the SCM 12 that runs independently of the other processes of the SCM 12, the Log Manager 40 will run regardless of whether the other processes are running, and likewise, the other processes will run regardless of whether the Log Manager 40 is running.

The Log Manager 40 preferably runs in a JVM on the CMS 14, remote from the clients 42 and the task manager 44 (the task manager 44 preferably runs on the CMS 14, but in a different JVM). Accordingly, as shown in FIG. 2, the clients 42 and the task manager 44 preferably access the Log Manager 40 through a Remote Method Invocation (“RMI”) interface 46. The RMI interface 46 enables the remote accessing of the Log Manager 40.

The Log Manager 40 preferably depends on clients 42 and the task manager 44 only so far as the clients 42 and the task manager 44 create valid log entries and use the Log Manager 40 interface (e.g., MxLogManagerIfc discussed below) correctly. For example, the clients 42 and the task manager 44 are preferably responsible for setting a time stamp for the log entries. The Log Manager 40 preferably checks log entries received for errors (i.e., the Log Manager 40 catches exceptions). For example, the Log Manager 40 may throw an exception (i.e., indicate an error) if an unreasonable number (e.g., ten (10) entries from the same consumer) of log entries contain the same time stamp (e.g., indicating a possibility that the clients 42 and task manager 44 are not updating the time stamp). Other exceptions may indicate that the time stamp is undefined or that an unmatched end of log is submitted, for example. However, in a preferred embodiment, the Log Manager 40 does not throw exceptions so as not to interfere with performance of the configuration or task event.

The Log Manager 40 preferably reads log attributes from a properties file to run properly and to create and maintain the log file 401. The log attributes may comprise: log file size, log file path, log file name, log file extension, host name (e.g., the CMS 14 name) on which the Log Manager 40 is running, port number that the Log Manager 40 uses for RMI transport, and log fifo queue size. Preferably, CLI arguments are not required to start the Log Manager 40; instead, the needed parameters are read from the properties file by the Log Manager 40. The needed parameters preferably include the host name, port number, and the log file data. However, these parameters may be supplied from a CLI or GUI (e.g., for development and test purposes), in which case the parameter values override the properties file values.

The Log Manager 40 preferably rolls-over the log file 401 (e.g., locks the log fifo queue, flushes the log fifo queue, writing the log entries in the log fifo queue to the log file 401, closes and archives the log file 401 as, for example, old_logfile and opens a new log file 401) when the log file 401 reaches the log file size. Again, the log file size is preferably kept in the properties file. Therefore, a user preferably edits the log file size in the properties file and re-starts the Log Manager 40 to change the log file size.

In an embodiment, the following Java classes preferably provide the primary mechanisms for implementing the Log Manager 40 logging capabilities: MxLogManagerImpl, MxLogManagerIfc, MxLogManger and MxLog. The MxLogManagerImpl class preferably is a Java RMI server and provides access to the Log Manager 40 logging functionality. The MxLogManagerIfc class preferably provides an interface (i.e., the RMI interface 46) that enables clients 42 and the task manager 44 to remotely access the Log Manager 40. Accordingly, the MxLogManagerImpl class implements the MxLogManagerIfc interface to provide the services necessary for consumers (i.e., collectively, clients 42 and the task manager 44) to log events.

The MxLogManager class preferably is a utility class that is a public interface to the Log Manager 40. A utility class is a class that is only instantiated as a single instance. The MxLogManager class handles concurrent processing of operations that request writes to the log file. The MxLogManager class handles this concurrent processing by ensuring that only a single instance of the MxLogManager class is instantiated as an object. The MxLogManager preferably enforces its singleton status by providing only a private constructor and a static method by which external objects, such as MxLogManagerImpl, access the MxLogManager.

The MxLog class preferably defines the attributes of a log entry, and provides accessor and mutator methods (e.g., get and set methods) necessary to modify those attributes. Each log entry is a single instance of the MxLog class instantiated as an MxLog object. MxLog objects are serializable to allow remote access via the Java RMI mechanism. The consumers of the Log Manager 40 interface “new” MxLog objects (i.e., the consumers instantiate the MxLog class) and set the attributes of the new MxLog objects specific to the consumer's component (e.g., the consumer's object). The consumers then present the filled-in MxLog object to the Log Manager 40 via the RMI interface 46.

An MxTaskLog class is preferably a subclass of the MxLog class. The MxTaskLog subclass preferably exists for task-related events. Preferably, only the task manager 44 uses the MxTaskLog subclass to log task-related events. The MxTaskLog subclass preferably comprises additional attributes and accessors needed for logging tasks.

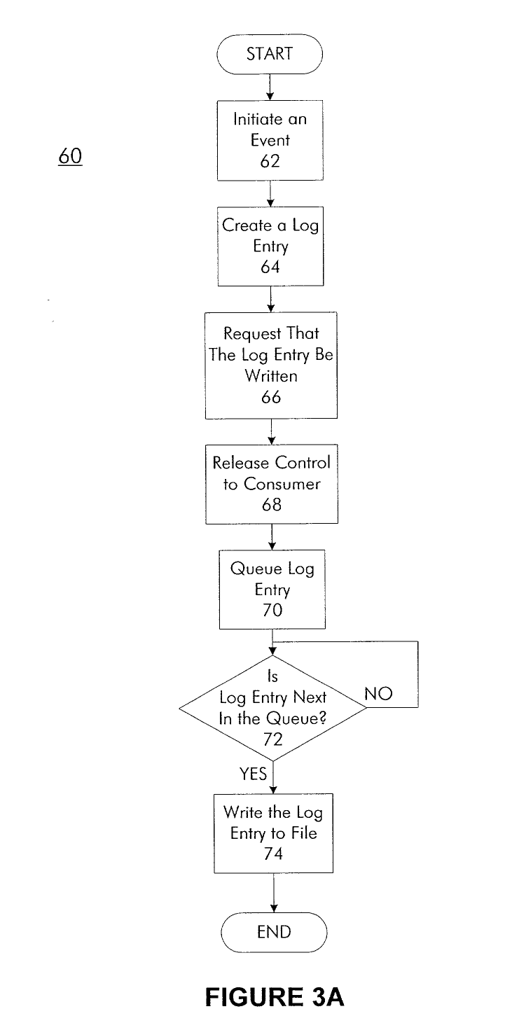

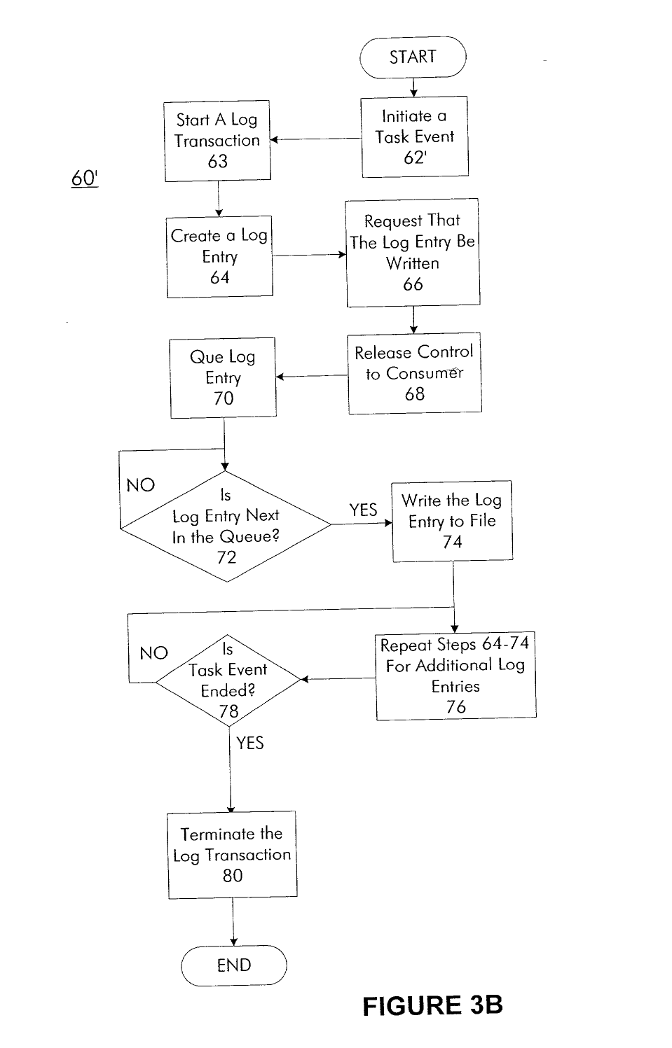

FIG. 3a illustrates a method for logging events 60, according to the present invention. As shown, the method 60 comprises initiating an event 62, creating a log entry 64, requesting that the log entry be written 66, releasing control to consumer 68, queuing log entry 70, determining if the log entry is next in the queue 72 and writing the log entry to file 74. Initiating an event 62 preferably comprises a consumer (e.g., a client 42 or task manager 44) beginning a configuration or task event (e.g., beginning the listing of nodes 16 in the SCM cluster 17 or starting the running of a tool on a target). When an event occurs, the consumer requests that the event's occurrence be logged. An event is a process executed by the SCM 12 on the computer system 10.

Creating the log entry 64 preferably comprises the consumer filling out a log entry with information that describes the event. In an embodiment, the consumer fills out the log entry by instantiating the MxLog class to create a new MxLog object (e.g., myLog), and calling the MxLog accessor and mutator methods to set the attributes of the MxLog object to describe the event. The attributes preferably describe the event and include a time-stamp.

Requesting that the log entry be written 66 preferably comprises the consumer requesting that the log entry information be written to a log, for example, by submitting the log entry to the Log Manager 40. In an embodiment, the consumer submits a write request including the log entry to the Log Manager 40 by invoking a logIt Log Manager 40 method and including the MxLog object (e.g., myLog) as a parameter of the logIt method invocation (e.g., logManager.log ( myLog)). When the logIt method is invoked, the Log Manager 40 may conduct an error check, attempting to catch any exceptions in the log entry (in the MxLog object). Possible exceptions include a zero time stamp or a repeated time stamp.

When a consumer requests that log entry be written 66, the consumer surrenders control of the log entry and cannot continue executing the initiated event until control is released to the consumer. Releasing control to consumer 68 preferably comprises releasing control of the log entry and allowing the consumer to resume executing the initiated event. In an embodiment, the Log Manager 40 clones the MxLog object included logIt method invocation and releases control of the original MxLog object to the consumer. This allows the consumer to continue executing the event or to initiate a new event.

Queuing the log entry 70 preferably comprises the Log Manager 40 placing the log entry in a fifo queue. In an embodiment, the Log Manager 40 provides a first thread that places the MxLog object (e.g., myLog) on a fifo queue that the Log Manager 40 maintains. The fifo queue pushes log entries (e.g., MxLog objects) out of the queue on a first in, first out basis.

Determining if the log entry is next in the queue 72 preferably comprises the Log Manager 40 determining if the current log entry is the oldest log entry in the fifo queue. In an embodiment, when the current MxLog object (e.g., myLog) is the oldest MxLog object in the fifo queue, the fifo queue may indicate that it is the current MxLog object's turn to be logged.

When the log entry is next in the queue, the Log Manager 40 preferably retrieves the log entry from the fifo queue, localizes the log entry and writes the log entry information to a log file. Accordingly, in an embodiment, writing the log entry 74 comprises the Log Manager 40 providing a second thread to get the MxLog object (e.g, myLog) off of the queue, localizing the MxLog object and writing the MxLog object to the log file 401. Writing and localizing the MxLog object to the log file 401 preferably comprises the Log Manager 40 getting the log information from the MxLog object, mapping the log information to strings in the local language (e.g., English) and writing the log information strings as ASCII text in the log file 401.

The Log Manager 40 preferably keeps separate, but related task event log entries together in one log file 401 and preferably will not roll over the log file 401 such that these separate, but related log entries would be split up (i.e., one in the log file 401 and one in an archived log file). Consequently, if the event is a task event, the method for logging task events 60′ may comprise additional steps, as shown in FIG. 3b. The method for logging task events 60′ preferably comprises initiating a task event 62′, starting a log transaction 63, creating a log entry 64, requesting that the log entry is written 66, releasing control to consumer 68, queuing log entry 70, determining if the log entry is next in the queue 72, writing the log entry 74, repeating steps 64-74 for additional log entry(ies) 76, determining if task event is ended 78, and terminating the log transaction 80.

Starting a log transaction 63 preferably comprises a consumer sending a message that a sequence of related task log entries are to be sent. In an embodiment, a task manager 44 tells the Log Manager 40 that a sequence of related task log entries will be sent by calling a Log Manager 40 method startLogTransaction( ). The Log Manager 40 preferably keeps track of the number of startLogTransaction( ) method calls (starts) and of corresponding endLogTransaction(0) method calls (ends). When the number of starts and ends matches, the Log Manager 40 may roll-over the log file, since no related log entries will be split up.

Generally, there are log entries corresponding to the initiation of a task event and the end of a task event. There may also be additional, intermediate log entries during execution of the task event. Accordingly, repeating steps 64-74 for additional log entry(ies) preferably comprises the task manager 44 creating and submitting an additional log entry or additional log entries, and the Log Manager 40 processing the additional log entry or log entries, as described with reference to FIG. 3a.

Determining if task event is ended 78 preferably comprises determining if the task event has completed or if the task event has failed to complete (e.g., the task manager 44 crashed while executing the task). If the task event has completed, the task manager 44 preferably terminates the log transaction 80. Consequently, in an embodiment, terminating the log transaction 80 comprises the task manager 44 calling the Log Manager 40 endLogTransaction( ) method after the last task log entry in the sequence. Termination of the log transaction indicates that a sequence of log entries associated with the task event has ended. As stated above, a matching number of starts and ends indicate that the log file 401 may be rolled over. If a certain amount of time has passed without receiving an endLogTransaction, the Log Manager 40 preferably assumes that the task event has failed to complete and rolls-over the log file 401.

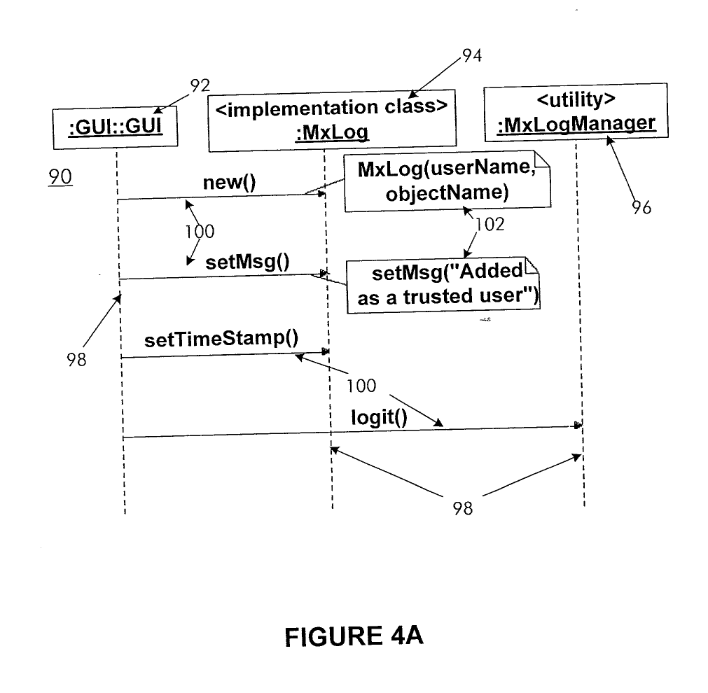

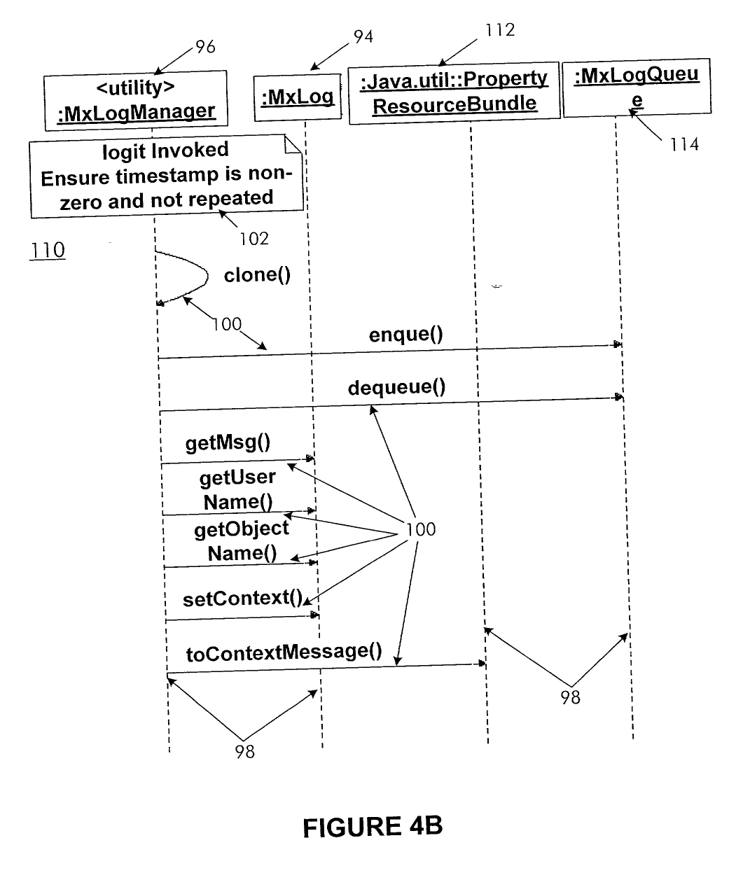

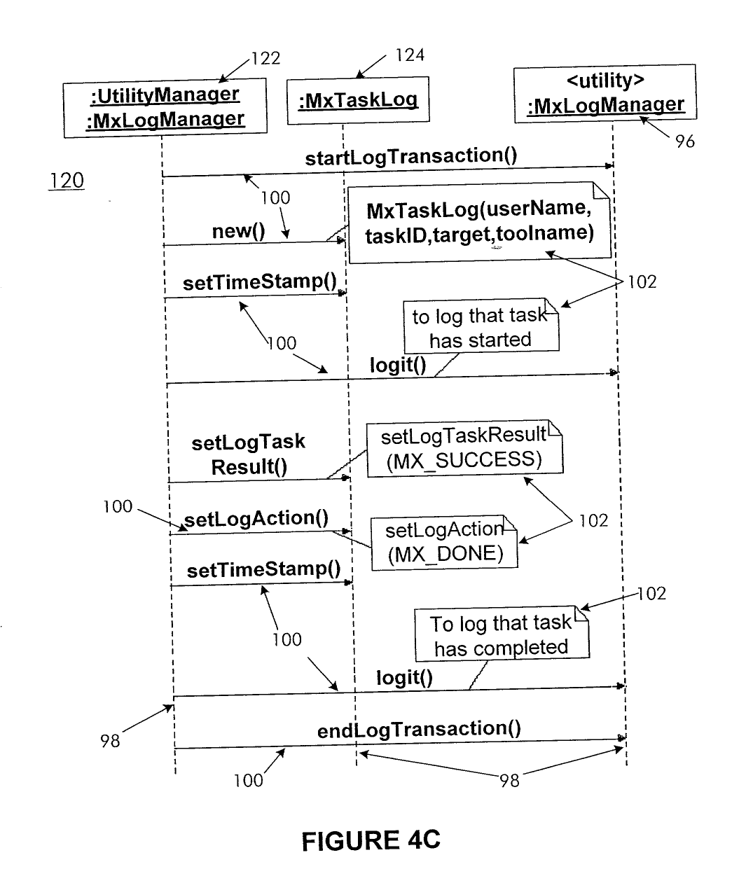

FIGS. 4a-4c are sequence diagrams illustrating a sequence of method calls for logging an event according to an embodiment of the present invention. FIG. 4a illustrates a series of method calls for creating a log entry and submitting the log entry to the Log Manager 40. These method calls correspond to step 64 and step 66 of the method shown in FIG. 3a. The sequence diagram 90 includes boxes representing a client GUI 92, the MxLog implementation class 94 and the MxLogManager utility class 96, which represents the Log Manager 40. Descending from the representations of the GUI 92, MxLog class 94 and MxLogManager class 96 are vertical time-lines 98 that represent the period of execution of the GUI 92, MxLog class 94 and MxLogManager class 96. Extending from invoking time-lines 98 to target time-lines 98 are method call lines 100 that represent methods invoked by the GUI 92 on a target class (i.e., the MxLog class 94 or the MxLogManager class 96). Also shown are notation boxes 102, which include comments regarding certain method call lines 100.

After the GUI has initiated an event (e.g., a configuration event), the GUI invokes a constructor (e.g., MxLog) in the MxLog class 94 to create a new MxLog object, as shown by a “new( )” call line 100. When populated with data, the new MxLog object will be the log entry submitted to the Log Manager 40. As shown by the associated notation box 102, the GUI may issue a method call new MxLog (userName, objectName) when the user ‘userName’ wants to create a log entry about a configuration of an object identified by ‘objectName.’ For example, the object being configured may be a user, node, node group, tool, role, authorization or other type of object.

A setMsg( ) method call line 100 indicates that the GUI 92 invokes a MxLog class 94 method setMsg( ) that preferably sets the text of the new log entry. For example, as shown by the associated notation box 102, the GUI could issue a method call setMsg(“Added as a trusted user”), which would set “Added as a trusted user” as the text of the new log entry. Preferably, the text of the log entry describes the event (e.g., a configuration event adding a user as a trusted user).

A set TimeStamp( ) method call line 100 indicates that the GUI 92 invokes a MxLog class 94 method setTimeStamp( ) that preferably sets the new log entry time stamp. The GUI 92 preferably provides the actual time for the time stamp.

The GUI 92 may invoke additional or different MxLog class 94 methods, depending on the data that is included in the new log entry. After the new MxLog object has been constructed and populated (i.e., the log entry has been completed), the GUI 92 invokes a MxLogManager class 96 method to submit the new MxLog object to the Log Manager 40. This method invocation is shown by the logIt( ) method call line 100. The parameter included in the logIt( ) is the name of the new MxLog object (e.g., myLog). The logIt( ) method submits the new MxLog object to the Log Manager 40 and requests that the Log Manager 40 log the new MxLog object (i.e., requests writing of the new log entry to the log file 401).

FIG. 4b illustrates a series of method calls for queuing and de-queuing the log entry and writing the log entry to the log file 401. The sequence diagram 110 in FIG. 4b includes boxes representing the MxLogManager class 96, representing the Log Manager 40, the MxLog class 94, a Java Property Resource Bundle utility 112 and a MxLogQueue class 114. The MxLogQueue class 114 is an interface to the log queue maintained by the Log Manager 40. As with the sequence diagram 90 in FIG. 4a, the sequence diagram 110 includes time-lines 98, method call lines 100 and a notation box 102.

The notation box 102 indicates that the Log Manager 40 has received the log entry and a request to write the log entry to the log file 401 (i.e., the MxLogManager class 96 method logIt has been invoked, as shown in FIG. 4a). When the Log Manager 40 receives the log entry (i.e., the MxLog object), the MxLogManager class 96 may execute catch exceptions code to check for errors. For example, the MxLogManager class 96 may check to ensure that the log-entry time stamp is non-zero or that the time stamp is not a repeated time stamp. If an error is found, the MxLogManager class 96 may execute error condition code to, for example, return the log entry to the GUI 92 so that the error is corrected.

If no errors are found, the MxLogManager class 96 preferably clones the MxLog object. The clone( ) method call line 100 indicates that the MxLogManager class 96 makes a self-referential method call to invoke a MxLogManager class 96 method. Cloning of the MxLog object returns control to the GUI 92 so that the GUI 92 can continue to execute the event (e.g., the configuration of a new user object).

The enque( ) method call line 100 indicates that the MxLogManager class 96 invokes a MxLogQueue class 114 method to place the cloned MxLog object in the queue. The enque( ) method call line 100 also represents a first thread of the Log Manager 40 that the Log Manager 40 generates to place log entries in the queue. As stated above, the Log Manager 40 is preferably a multiple threaded process. The cloned MxLog object name (e.g., myLog) is preferably included as the enque( ) method parameter. Java synchronization features preferably handle queue concurrency issues (e.g., two log entries are sent to the Log Manager 40 for logging at the same time, as indicated by their time stamps).

The dequeue( ) method call line 100 indicates that the MxLogManager class 96 invokes a MxLogQueue class 114 method to remove a cloned MxLog object from the queue. Preferably, the queue is a fifo queue and the dequeue( ) method will remove the oldest log entry from the queue. The dequeue( ) method call line 100 also represents a second thread of the Log Manager 40 that the Log Manager generates to remove log entries from the queue. The Log Manager 40 may keep track of the oldest log entry, and include the name of the oldest log entry as the dequeue method parameter. Alternatively, the queue itself determines the oldest log entry and returns it when the dequeue( ) method is invoked.

When the log entry is returned, the Log Manager 40 writes the data contained in the log entry to the log file 401. Preferably, this comprises the MxLogManager class 96 invoking MxLog class 94 methods to retrieve data from the MxLog object returned from the queue. The getMsg( ) method call line 100 illustrates an invocation of the MxLog class 94 method that accesses the text of the log entry and returns the text to the Log Manager 40. Likewise, the getUserName( ) method call line 100 illustrates invocation of the MxLog class 94 method that accesses the user name of the user that initiated the event that is described by the log entry and returns the user name to the Log Manager 40. The getObjectName( ) method call line illustrates an invocation of the MxLog class 94 method that accesses the object name of the MxLog object.

The setContext( ) method call line 100 illustrates invocation of the MxLog class 94 method that sets a context of the log entry. The context preferably comprises the language in which the log entry will be written. The normal default context is English. If the Log Manager 40 is used in a system 10 that requires a different language, the context may be set to the different language (e.g., Japanese) and the log entry will be written in that different language.

The toContextMessage( ) method call line 100 illustrates invocation of the Property Resource Bundle Java utility 112 method that writes the text of the log entry (i.e., the strings contained in the MxLog object attributes) to the log. The language used is determined by the context set by the preceding setContext method. The toContextMessage( ) method takes the string attributes of the MxLog object passed with invocation of toContextMessage( ) method and writes these strings in the log file 401.

FIG. 4c illustrates a series of method calls, generally corresponding to FIG. 3b, for creating task log entries and submitting task log entries to the Log Manager 40 when a task is performed. A task is the running of a tool with targets. The sequence diagram 120 shown in FIG. 4c includes boxes representing an MxTaskManager utility class 122, which represents the task manager 44, a MxTaskLog implementation class 124, which preferably is a sub-class of the MxLog implementation class 94, and the MxLogManager utility class 96, which represents the Log Manager 40. The startLogTransaction( ) method call line 100 indicates that the MxTaskManager class 122 is executing a task and is invoking a MxLog Manager 96 method to start a log transaction. Preferably, all related log entries in a log transaction (i.e., after the start of a log transaction and prior to the end of a log transaction) are kept together in the current log file 401. As discussed above, the Log Manager 40 preferably keeps track of startLogTransaction( ) method invocations (“starts”) and endLogTransaction( ) method invocations (“ends”) and will only roll-over the log file 401 when the number of starts and ends are equal. This roll-over rule prevents the separation of related log entries into current and archived log files.

The new( ) method call line 100 indicates that the MxTaskManager class 122 invokes a MxTaskLog class124 constructor method (e.g., MxTaskLog) to construct a new MxTaskLog object. When populated with data, the new MxTaskLog object will be the task log entry submitted to the Log Manager 40. As shown by the associated notation box 102, the task manager 44 may issue a method call new MxLog (userName,taskID,target,toolName) when the user ‘userName’ wants to create a task log entry about the task identified by ‘taskID’, which is executed on a target node(s) or node group(s) identified by ‘target’ with the tool ‘toolName.’ A tool in the SCM 12 performs various tasks on a target node or node group, and may perform tasks on multiple nodes or node groups when the tool is a multi-system aware tool. Preferably, the first MxTaskLog object is a task log entry that indicates that the task has started.

A set TimeStamp( ) method call line 100 indicates that the MxTaskManager class 122 invokes a MxTaskLog class 124 method setTimeStamp( ) that preferably sets the new log entry time stamp. The MxTaskManager class 122 preferably provides the actual time for the time stamp.

The MxTaskManager class 122 may invoke additional or different MxTaskLog class 124 methods, depending on the data that is included in the new task log entry. After the new MxTaskLog object has been constructed and populated (i.e., the task log entry has been completed), the MxTaskManager class 122 invokes a MxLogManager class 96 method to submit the new MxTaskLog object to the Log Manager 40. This method invocation is shown by the logIt( ) method call line 100. The parameter included in the logIt( ) is the name of the new MxTaskLog object (e.g., myTaskLog). The logIt( ) method submits the new MxTaskLog object to the Log Manager 40 and requests that the Log Manager 40 logs the new MxTaskLog object (i.e., requests writing of the new task log entry to the log file 401).

As the task is executed and completed, the task manager 44 preferably creates one or more additional task log entries. Rather than creating a new MxTaskLog object for each additional task log entry, the task manager 44 may simply modify the attributes of the MxTaskLog object created above and re-submit the modified MxTaskLog object to the Log Manager 40. Accordingly, the setLogTaskResult method call line 100 indicates that the MxTaskManager class 122 invokes a MxTaskLog class 124 method to set a MxTaskLog object attribute that indicates the result of the task (e.g., whether a success, failure, in progress, some failures, canceled or killed). In the example sequence diagram 120 shown, the task is a success. Consequently, as shown by the associated notation box 102, the MxTaskManager class 122 invoked the MxTaskLog class 124 method setLogTaskResult(MX_SUCCESS).

The setLogEvent( )method call line 100 indicates that the MxTaskManager class 122 invokes a MxTaskLog class 124 method to set a MxTaskLog object attribute that indicates what type of event is being logged. For example, the event logged may be the completion of the task (i.e., done), the start of the task (i.e., start) or the completion of an intermediate step (e.g., file copies). In the example sequence diagram 120 shown, the task is done. Consequently, as shown by the associated notation box 102, the MxTaskManager class 122 invoked the MxTaskLog class 124 method setLogEvent(MX_DONE).

As with the previous entries shown above, the task manager 44 preferably sets the time-stamp of the present task log entry (i.e., the modified MxTaskLog object). Consequently, the setTimeStamp( ) method call line 100 indicates that the MxTaskManager class 122 invokes the MxTaskLog class 124 method setTimeStamp( ) to set the new log entry time stamp.

After the MxTaskLog object has been modified, the MxTaskManager class 122 invokes the MxLogManager class 96 logIt( ) method to submit the new MxTaskLog object to the Log Manager 40. The logIt( ) method submits the modified MxTaskLog object to the Log Manager 40 and requests that the Log Manager 40 logs the modified MxTaskLog object (i.e., requests writing of the new task log entry to the log file 401). In the example shown, as indicated by the associated notation box 102, the logIt( ) method is invoked to log that the task is completed.

The endLogTransaction( ) method call line 100 indicates that the MxTaskManager class 122 invokes the MxLogManager class 96 method to end the current log transaction. As discussed above, when the number of starts equals the number of ends (e.g., after the endLogTransaction( ) method is invoked) the Log Manager 40 may roll-over the log file 401.

While the Independent Log Manager has been described with reference to the exemplary embodiments thereof, those skilled in the art will be able to make various modifications to the described embodiments without departing from the true spirit and scope of the Independent Log Manager. The terms and descriptions used herein are set forth by way of illustration only and are not meant as limitations. Those skilled in the art will recognize that these and other variations are possible within the spirit and scope of the Independent Log Manager as defined in the following claims and their equivalents.

What is claimed is:

1. A method for logging events independently and separately from other processes in a computer system, comprising:
initiating an event, wherein the event is a process executed on a computer system;
creating a log entry, wherein the log entry comprises information that describes the event;
requesting that the log entry information be written to a log file, whereby the consumer surrenders control of the log entry, pausing execution of the event; and
releasing control of the log entry to the consumer, so that execution of the event can resume, prior to writing the log entry information to the log file, wherein releasing control of the log entry to the consumer comprises:
cloning the log entry, wherein the log entry clone is a copy of the log entry that comprises the log entry information.

2. The method of claim 1, wherein the cloning step is performed by a multiple-threaded log manager.

3. The method of claim 1, further comprising:
queuing the log entry clone in a queue that determines when the log entry information is written to the log file.

4. The method of claim 3, wherein the queue is a first in, first out queue.

5. The method of claim 3, wherein at some time the log entry clone has a turn, the method further comprising:
determining if the log entry clone is next in the queue; and,
if the log entry clone is next in the queue, writing the log entry information to log file.

6. The method of claim 1, wherein the log entry is an object comprising attributes populated with the log entry information.

7. The method of claim 1, wherein the event is a configuration event.

8. The method of claim 1, wherein the consumer is a client.

9. The method of claim 1, wherein the event is a task event, the method further comprising:
starting a log transaction, wherein starting a log transaction comprises a consumer sending a message that a sequence of related task log entries are to be sent.

10. The method of claim 9, further comprising
determining if the task event has ended, wherein the end of the task event comprises the completion of the task event or a failure to complete the task event; and,
if the task event has ended, terminating the log transaction, wherein terminating the log transaction indicates that a sequence of log entries associated with the task event has ended and that the log file may be rolled-over without interrupting logging of the task event.

11. The method of claim 9, wherein the consumer is a task manager.

12. A computer readable medium containing instructions for logging events independently and separately from other processes in a computer system, by:
a consumer initiating an event, wherein the event is a process executed on a computer system;
creating a log entry, wherein the log entry comprises information that describes the event;
requesting that the log entry information be written to a log file, whereby the consumer surrenders control of the log entry, pausing execution of the event; and,
releasing control of the log entry to the consumer, so that execution of the event can resume, prior to writing the log entry information to the log file.

13. The computer readable medium of claim 12, wherein releasing control of the log entry to the consumer comprises:
cloning the log entry, wherein the log entry clone is a copy of the log entry that comprises the log entry information.

14. The computer readable medium of claim 13, further comprising instructions for logging events entries independently and separately from other processes in a computer system, by:
queuing the log entry clone in a queue that determines when the log entry information is written to the log file.

15. The computer readable medium of claim 14, wherein the log entry clone has a turn, further comprising instructions for logging events entries independently and separately from other processes in a computer system, by:
determining if the log entry clone is next in the queue; and,
if the log entry clone is next in the queue, writing the log entry information to log file.

16. The computer readable medium of claim 12, wherein the log entry is an object comprising attributes populated with the log entry information.

17. A computer system that supports logging events independently and separately from other processes in a computer system, comprising:
a memory, that stores an application;
a secondary storage device comprising a log file;
a processor that runs the application, wherein the application comprises:
a consumer, wherein the consumer initiates an event that is a process executed by the processor, creates a log entry comprising information that describes the event, and requests that the log entry information be written to the log file;
a multiple-threaded log manager, wherein the log manager, independently and separately from other processes, logs events, by:
receiving the log entry from the consumer, thereby obtaining control of the log entry and pausing execution of the event; and,
releasing control of the log entry to the consumer, so that execution of the event can resume, prior to writing the log entry information to the log file.

18. The computer system of claim 17, wherein releasing control of the log entry to the consumer comprises:
the log manager cloning the log entry, wherein the log entry clone is a copy of the log entry that comprises the log entry information.

19. The computer system of claim 17, wherein the consumer is a task manager.

20. The computer system of claim 17, wherein the log entry is an object that comprises attributes which are populated with the log entry information.
